(19) United States
(12) Patent Application Publication
(10) Pub. No.: US 2026/0216774 A1
(43) Pub. Date: Jul. 30, 2026

(54) SYSTEMS AND METHODS FOR PRODUCING EXTRUDED MATERIALS FROM LOOSE CHIPS

(71) Applicants: NISSAN NORTH AMERICA, INC., Franklin, TN (US); UNIVERSITY OF NORTH TEXAS, Denton, TX (US)

(72) Inventors: Sandeep PATIL, Farmington Hills, MI (US); Nanzhu ZHAO, Novi, MI (US); Anurag Krishnakedar GUMASTE, Denton, TX (US); Ravi sankar HARIDAS, Denton, TX (US); Rajiv S. MISHRA, Denton, TX (US)

(21) Appl. No.: 19/040,371

(22) Filed: Jan. 29, 2025

(51) Int. Cl. B21C 23/01; B23K 20/12

(52) U.S. Cl. CPC B21C 23/01; B23K 20/1225; B23K 20/1255

(57) ABSTRACT

Systems and methods for producing recycled or upcycled extruded material from loose chips are disclosed herein. In an embodiment, the system includes a rotational tool, a housing and a motor. The rotational tool includes an auger portion that transitions to a friction stirring portion. The housing has an inlet configured to receive loose chips, an outlet configured to output extruded material, and a tool cavity connecting the inlet and the outlet. The tool cavity includes a compression zone containing the auger portion of the rotational tool, a plasticization zone containing the friction stirring portion of the rotational tool, and a transition zone surrounding the rotational tool where the auger portion transitions to the friction stirring portion. The motor rotates the rotational tool within the tool cavity to cause loose chips to flow from the inlet, through the tool cavity, and out of the outlet as extruded material.

### BACKGROUND

### Field of the Disclosure

The present disclosure generally relates to systems and methods of recycling or upcycling loose chips created during various manufacturing processes. The present disclosure also generally relates to systems and methods for producing extruded materials in a variety of shapes and sizes from the loose chips in a single step.

### Background Information

Metals are used in a wide variety of structural applications. Recycling steel and aluminum conserves significant energy, reducing energy consumption by 70% and 95%, respectively, compared to mining and refining their ores. Recycling metal also emits 80% less carbon dioxide than production from raw materials. Various recycling/upcycling systems such as melting and casting exist, but there is room for improvement to both the tools involved and to the quality of resulting recycled/upcycled materials.

### SUMMARY

The present disclosure provides systems and methods of recycling or upcycling loose metal chips into extruded metal materials such as rods, wires, tubes and metal matrix composites in a single-step. The systems and methods described herein are advantageous because they enable loose metal chips left over from various manufacturing processes to be directly recycled or upcycled into extruded materials using a single rotational tool having a dual tool design. It has been determined that the systems and methods described herein can create extruded materials that have little or no impurities or defects, as well as improved mechanical properties such as tensile strength, yield strength, ductility and hardness compared to existing methods such as melting and casting.

In view of the state of the known technology, one aspect of the present disclosure is to provide a system for producing an extruded material from loose chips. The system includes a rotational tool, a housing and a motor. The rotational tool is configured to rotate around a center axis thereof and includes an auger portion that transitions to a friction stirring portion along the center axis. The housing has an inlet configured to receive the loose chips, an outlet configured to output the extruded material, and a tool cavity connecting the inlet and the outlet. The tool cavity includes a compression zone containing the auger portion of the rotational tool, a plasticization zone containing the friction stirring portion of the rotational tool, and a transition zone surrounding the rotational tool where the auger portion transitions to the friction stirring portion. The motor is configured to rotate the rotational tool within the tool cavity to cause the loose chips to flow from the inlet, through the tool cavity, and out of the outlet as the extruded material.

A second aspect of the present disclosure is to provide another system for producing an extruded material from loose chips. The system includes a housing, a rotational tool and a motor. The housing has an inlet configured to receive the loose chips, an outlet configured to output the extruded material, and a tool cavity connecting the inlet and the outlet. The rotational tool is located within the tool cavity and configured to rotate around a center axis thereof. The rotational tool includes an auger portion and a friction stirring portion along the center axis. The auger portion has an auger thread configured to compress the loose chips received at the inlet. The friction stirring portion has a tapering diameter configured to plasticize the loose chips compressed by the auger portion to be output as the extruded material from the outlet. The motor is configured to rotate the rotational tool within the tool cavity to cause the loose chips to flow from the inlet, through the tool cavity, and out of the outlet as the extruded material.

A third aspect of the present disclosure is to provide a method for producing an extruded material from loose chips. The method includes feeding the loose chips into a tool cavity, compressing the loose chips with an auger portion of an rotational tool that is rotating around a rotational axis within the tool cavity, passing the compressed loose chips in an axial direction of the rotational axis through a transition zone of the tool cavity, plasticizing the compressed loose chips into a plasticized material with a friction stirring portion of the rotating tool that is rotating around the rotational axis within the tool cavity, and extruding the plasticized material from an outlet of the tool cavity.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a top perspective view of an example embodiment of a system configured to produce an extruded material from loose chips in accordance with the present disclosure;

FIG. 2 is a cross-sectional view of the system of FIG. 1;

FIG. 3 is a top perspective view of an example embodiment of a rotational tool forming part of the system of FIG. 1;

FIG. 4 is a side elevational view of the rotational tool of FIG. 3;

FIG. 5 is a top perspective view of an example embodiment of a processing split die forming part of the system of FIG. 1;

FIG. 6 is a side elevational view of the processing split die of FIG. 5;

FIG. 7 is a top perspective view of an example embodiment of a feeder die forming part of the system of FIG. 1;

FIG. 8 is a bottom perspective view of the feeder die of FIG. 7;

FIG. 9 is a side elevational view of the feeder die of FIG. 7;

FIG. 10 is a side elevational view of another example embodiment of a system configured to produce an extruded material from loose chips in accordance with the present disclosure;

FIG. 11 is another side elevational view of the system of FIG. 10;

FIG. 12 is a top perspective cross-sectional view of another example embodiment of a system configured to produce an extruded material from loose chips in accordance with the present disclosure;

FIG. 13 is a top perspective cross-sectional view of another example embodiment of a system configured to produce an extruded material from loose chips in accordance with the present disclosure;

FIG. 14 is a top perspective cross-sectional view of another example embodiment of a system configured to produce an extruded material from loose chips in accordance with the present disclosure;

FIG. 15 is a side elevational view of an alternative example embodiment of a rotational tool in accordance with the present disclosure;

FIG. 16 is a bottom elevational view of the rotational tool of FIG. 15;

FIG. 17 is a cross-sectional view taken through the center of the rotational tool of FIG. 15;

FIG. 18 is a side elevational view of an example embodiment of a system configured to produce an extruded material from loose chips in accordance with the present disclosure; and

FIG. 19 is a side elevational view of another example embodiment of a system configured to produce an extruded material from loose chips in accordance with the present disclosure.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

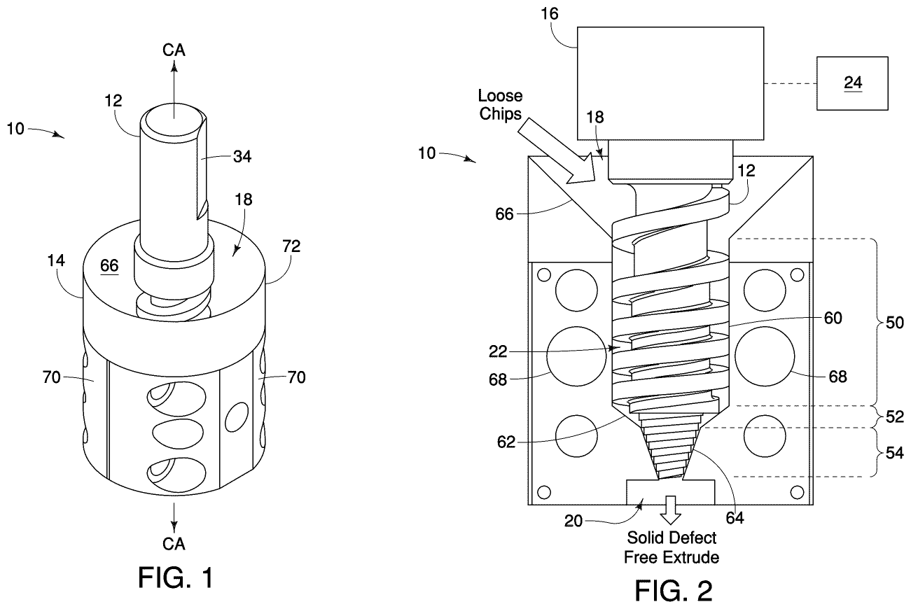

FIGS. 1 and 2 illustrate a first example embodiment of a system 10 configured to produce an extruded material from loose chips in accordance with the present disclosure. The loose chips are generally small metal chips generated during a manufacturing process. For example, a large amount of loose metal chips are generated during various vehicle manufacturing processes. The system 10 is configured to recycle/upcycle the loose chips to create extruded materials such as rods, wires, tubes and metal matrix composites. These extruded materials can be formed into useful parts such as pipes for HVAC and cooling systems and torsion bars for vehicles.

In the illustrated embodiment, the system 10 generally includes a dual-purpose rotational tool 12, a tool housing 14 and a motor 16. The housing 14 includes an inlet 18 configured to receive the loose chips, an outlet 20 configured to output the extruded material, and a tool cavity 22 connecting the inlet 18 and the outlet 20. As discussed in more detail below, the rotational tool 12 is located within the tool cavity 22 and configured to rotate around the center axis CA thereof. The motor 16 rotates the rotational tool 12 within the housing 14 to cause the loose chips to flow from the inlet 18, through the tool cavity 22, and out of the outlet 20 as the extruded material. The size and shape of the outlet 20 can be adjusted or modified as needed to extrude parts having different shapes and sizes. The system 10 can further include a controller 24 configured to control the motor 16 and/or other functions of the systems and methods disclosed herein.

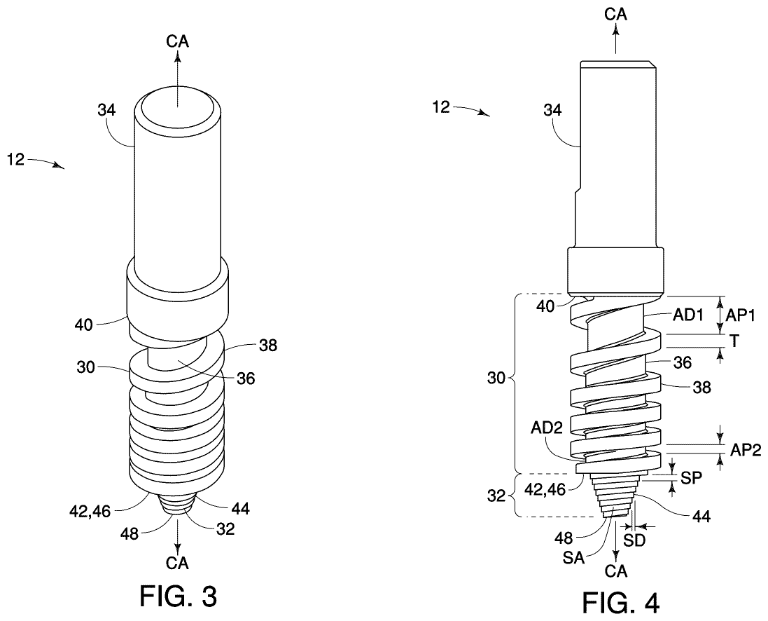

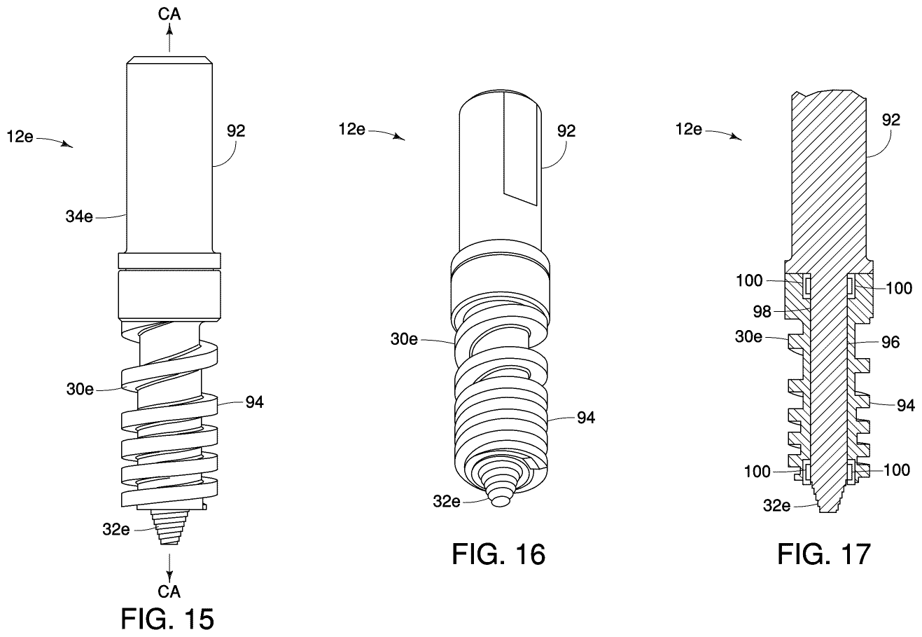

FIGS. 3 and 4 illustrate an example embodiment of the rotational tool 12 in more detail. The rotational tool 12 includes an auger portion 30 that transitions to a friction stirring portion 32 along the center axis CA thereof. The rotational tool 12 also includes a tool shank 34 located above the auger portion 30. The tool shank 34 is configured to operatively connect to and be rotated by the motor 16. In the illustrated embodiment, the auger portion 30, the friction stirring portion 32 and the tool shank 34 are all formed together as a single-piece tool, although an alternative embodiment of a rotational tool 12 formed of multiple pieces is shown in FIGS. 15 to 19 and discussed in more detail below.

The auger portion 30 is configured to compress the loose chips received at the inlet 18. In the illustrated embodiment, the auger portion 30 includes an auger shaft 36 and an auger thread 38. The auger thread 38 extends radially outward from the auger shaft 36 and winds continuously around the auger shaft 36 from the first end 40 of the auger portion 30 to the second end 42 of the auger portion 30, with the pitch of the auger thread 38 forming spaces which act as a type of reservoir for compressed loose chips. The first end 40 of the auger portion 30 is where the rotational tool 12 transitions from the tool shank 34 to the auger portion 30. The second end 42 of the auger portion 30 is where the rotational tool 12 transitions from the auger portion 30 to the friction stirring portion 32. The second end 42 of the auger portion 30 is therefore closer to the friction stirring portion 42 than the first end 40 of the auger portion 30.

In the illustrated embodiment, the auger shaft 36 and the auger thread 38 change dimensions from the first end 40 to the second end 42. As seen in FIG. 4, the auger shaft 36 has a diameter that gradually increases from the first end 40 to the second end 42. That is, the auger shaft 36 has a first diameter AD1 at the first end 40 and a second diameter AD2 at the second end 42, with the first diameter AD1 being smaller than the second diameter AD2. The auger thread 38 is also a variable pitched auger thread having a pitch that gradually decreases from the first end 40 to the second end 42. That is, the auger thread 38 has a first pitch AP1 at the first end 40 and a second pitch AP2 at the second end 42, with the first pitch AP1 being larger than the second pitch AP2. An advantage of generally dimensioning the auger portion 30 as shown is that the volume of the spaces between the auger thread 38 in the radial and axial directions becomes smaller as the loose chips are driven from the first end 40 to the second end 42, which causes the loose chips to become increasingly compressed both axially (by the decreasing pitch of the auger thread 38) and radially (by the increasing diameter of the auger shaft 36) as they approach the friction stirring portion 32. In the illustrated embodiment, the auger thread 38 has a constant thickness T, but varying the thickness T of the auger thread 38 from the first end 40 to the second end 42 is another way to structure the auger portion 30 to increasingly compress the loose chips as they are driven from the first end 40 to the second end 42. The auger portion 30 can also have a cylindrical auger shaft 36 and/or a constant pitched auger thread 38, as shown in the alternative example embodiments discussed below.

The friction stirring portion 32 has a tapering diameter and is configured to shear, plasticize and consolidate the loose chips compressed by the auger portion 30 so that the plasticized and consolidated material can be output as extruded material from the outlet 20. In the illustrated embodiment, the friction stirring portion 32 includes a stepped spiral forming a plurality of steps 44 which decrease in diameter from the first end 46 of the friction stirring portion 32 to the second end 48 of the friction stirring portion 32. The first end 46 of the friction stirring portion 32 is where the rotational tool 12 transitions from the auger portion 30 to the friction stirring portion 32. The second end 48 of the friction stirring portion 32 is where the extruded material is output from the outlet 20 in the axial direction. The first end 46 is therefore closer to the auger portion 30 than the second end 48. As seen in FIG. 4, the steps 44 have a step pitch SP, a step diameter SD and a step angle SA. In the illustrated embodiment, the step pitch SP, the step depth of cut SD and the step angle SA are constant from the first end 46 to the second end 48, but the step pitch SP, step depth of cut SD and/or step angle SA can vary from the first end 46 to the second end 48 in alternative embodiments. The exact step pitch SP, step depth of cut SD and/or step angle SA can vary depending on the materials and sizes of the rotational tool 12 and the loose chips.

The material of the rotational tool 12 can vary depending on the type of loose chips being plasticized and extruded. For example, the rotational tool 12 can be made of D2, H13 or A2 metal for processing softer loose chips such as aluminum, copper or magnesium. The rotational tool 12 can also be made of a tungsten-based, titanium zirconium molybdenum (TZM) alloy or polycrystalline cubic boron nitride (PCBN) material for processing loose chips made of a high temperature material like titanium or steel. Those of ordinary skill in the art will recognize from this disclosure that these are only a few examples and that other materials can also be used.

Referring again to FIG. 2, the housing 14 includes the tool cavity 22 which receives the rotational tool 12. The tool cavity 22 includes a compression zone 50, a transition zone 52 and plasticization zone 54. As seen in FIG. 2, during use of the system 10, the compression zone 50 contains the auger portion 30 of the rotational tool 12, the plasticization zone 54 contains the friction stirring portion 32 of the rotational tool 12, and the transition zone 52 surrounds the rotational tool 12 where the auger portion 30 transitions to the friction stirring portion 32. The rotational tool 12 can be raised or lowered within the tool cavity 22 to adjust the relative height of the rotational tool 12 within the tool cavity 22 to accommodate different materials and sizes of loose chip loads.

In the illustrated embodiment, the compression zone 50 includes an inner wall 60, the transition zone 52 includes an inner wall 62, and the plasticization zone 54 includes an inner wall 64. Here, the inner wall 60 is a vertical cylindrical inner wall with a constant diameter, the inner wall 62 is positioned at a first acute angle A1 (see FIG. 6) with respect to the center axis CA of the rotational tool 12, and the inner wall 64 is positioned at a second acute angle A2 (see FIG. 6) with respect to the center axis CA of the rotational tool 12. The first acute angle A1 is larger than the second acute angle A2, which creates a reservoir space between the rotational tool 12 and the inner wall 62 of the transition zone 52 as the compressed material transitions from the compression zone 50 into the plasticization zone 54, as seen for example in FIG. 2. This reservoir space is critical because it allows for a gradual transition of the compressed material from the compression zone 50 into the plasticized material in the plasticization zone 54, and it prevents the compressed material from being heated within the compression zone 50 before reaching the plasticization zone 54 which can clog the auger portion 30 of the rotational tool 12.

The rotational tool 12 does not contact the inner walls 60, 62, 64 of the tool cavity 22 during use of the system 10. The rotational tool 12 is instead lowered into the tool cavity 22 so that there is a small clearance between the auger portion 30 and the inner wall 60 of the compression zone 50 and a small clearance between the friction stirring portion 32 and the inner wall 64 and the plasticization zone 54. The amount of clearance will differ depending on the shape and size of chips. The rotational tool 12 is lowered into the appropriate position to maintain clearance between the rotational tool 12 and cavity wall 64 for appropriate plasticization and extrusion of chips during use.

In the illustrated embodiment, the inlet 18 encircles the center axis CA of the rotational tool 12 and is located above the compression zone 50 in an axial direction of the center axis CA. More specifically, the inlet 18 includes an inclined inner wall 66 which angles inward toward the compression zone 50. That is, the inlet 18 includes a cavity that decreases in diameter closer to the compression zone 50. This way, loose chips can be placed in the top of the inlet 18 and travel to the compression zone 50 using gravity without an additional action being needed. In the illustrated embodiment, the inclined inner wall 66 fully encircles the rotational tool 12, so that loose chips can be placed into the inlet 18 from any side of the housing 14. Alternatively, the inlet 18 can partially encircle the rotational tool or be located in other positions, as shown for example in the alternative example embodiments discussed below.

In the illustrated embodiment, the housing 12 includes a cooling jacket 68 located radially outward from the tool cavity 22 with respect to the center axis CA of the rotational tool 12. More specifically, the cooling jacket 68 is located radially outward from the compression zone 50 because the system 10 can become clogged if the compression zone 50 reaches high temperatures and begins to plasticize the compressed material before it reaches the plasticization zone 54. The cooling jacket 68 has a cooling liquid flow therethrough to control the temperature of the compression zone 50. In an embodiment, the controller 24 automatically controls cooling liquid flow through the cooling jacket 68 based on a detected temperature in or near the compression zone 50. For example, the controller 24 can automatically control the temperature and/or flow rate of the cooling liquid based on the detected temperature.

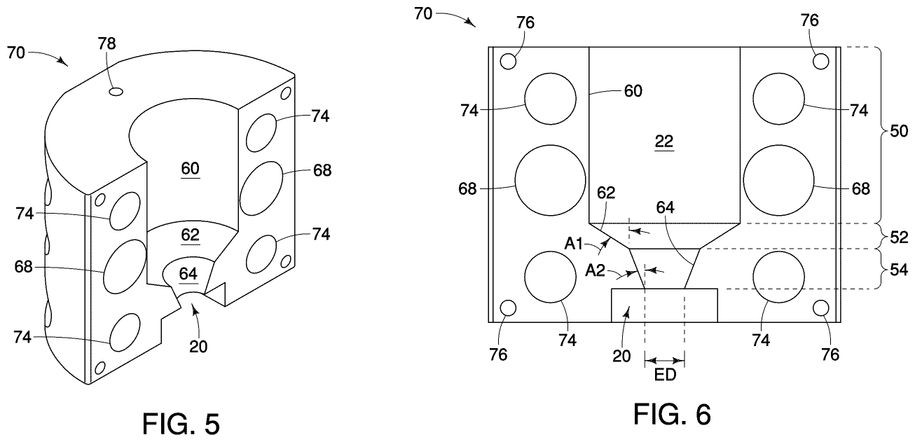

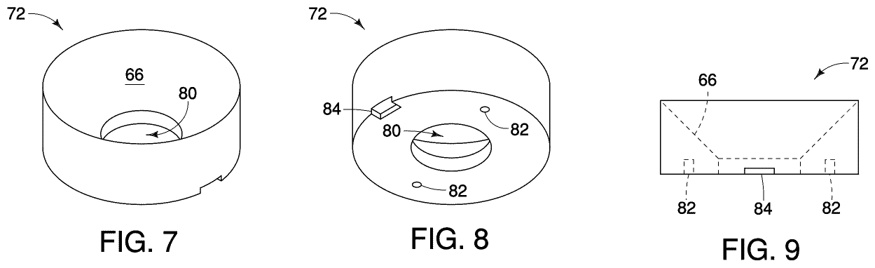

FIGS. 5 to 9 illustrate parts of the housing 14 in more detail. In the illustrated embodiment, the housing 14 is formed by two processing split dies 70 and a feeder die 72 that are attached to each other. FIGS. 5 and 6 illustrate an example embodiment of a processing tool die 70, and FIGS. 7 to 9 illustrate an example embodiment of the feeder die 72. In alternative embodiments, these parts can be combined or further separated into multiple parts.

As seen for example in FIGS. 5 and 6, each processing split die 70 forms part (e.g., half) of the tool cavity 22, such that the tool cavity 22 is formed between the processing split dies 70 when the processing split dies 70 are attached to each other. In the illustrated embodiment, the two processing split dies 70 are identical and attach to each other via bolt holes 74. Each processing split die 70 has a provision for cooling jacket 68. Each processing split die 70 also includes locating holes 76 for respective dowel pins to assist with accurate positioning the processing split dies 70 against each other.

The feeder die 72 forms the inlet 18 of the housing 14. More specifically, the feeder die 72 forms a tapered extension of the tool cavity 22 surrounding an upper part of the rotational tool 12. As seen for example in FIGS. 7 to 9, the feeder die 72 includes a cavity 80, locating pin holes 82 and a notch 84. The cavity 80 includes the inner surface 66 which angles inwardly from the top to the bottom of the feeder die 72 to create the inlet 18 cavity. The locating pin holes 82 receive respective dowel pins to assist with accurate positioning of the feeder die 72 against the processing split dies 70. The notch 84 assists with disassembly when the feeder die 72 is removed from the processing split dies 70.

Referring again to FIG. 2, the motor 16 is configured to rotate the rotational tool 12 around its center axis CA to cause the loose chips to flow from the inlet 18, through the tool cavity 22, and out of the outlet 20 as the extruded material. Here, the center axis CA is a vertical axis. The optimal speed of rotation depends on the materials used for the rotational tool 12 and the loose chips being recycled/upcycled.

The controller 24 is configured to control the motor 16. The controller 24 preferably includes a microcomputer with a control program that controls the motor 16. The controller 24 can also include other conventional components such as an input interface circuit, an output interface circuit, and storage devices such as a ROM (Read Only Memory) device and a RAM (Random Access Memory) device. The memory circuit stores processing results and control programs such as ones for operation that are run by the processor circuit. The microcomputer of the controller 24 is programmed to control the motor 16 by controlling and/or adjusting the speed of the motor 16. The controller 24 can be operatively coupled to the motor in a conventional manner. The controller 24 is also capable of selectively controlling any of the other components of the system 10 in accordance with one or more control programs.

In various embodiments, the controller 24 is configured to control the rotational speed of the rotational tool 12, the positioning of the rotational tool 12 with respect to the housing 14 and/or within the tool cavity 22, and/or the feed rate that the loose chips are fed into the inlet 18. In an embodiment, the controller 24 controls the rotational speed of the rotational tool 12 using a feedback circuit. In an embodiment, the controller 24 adjusts the rotational speed based on a detected torque, a detected temperature, force for extrusion or other factors. For example, the controller 24 can slow the rotational tool 12 if the detected torque is higher than a predetermined threshold. In another example, the controller 24 can slow the rotational tool 12 and/or lower the temperature of the cooling jacket 68 if the temperature at the compression zone 50 is determined to be higher than a predetermined threshold. Similarly, the controller 24 can speed up the rotational tool 12 if the temperature in the plasticization zone is determined to be lower than a predetermined threshold. In another example, the controller 24 can automatically adjust a spindle rotation rate that the loose chips are fed from inlet 18 into the cavity based on a detected torque of the rotational tool 12 and/or a detected temperature within the tool cavity 22.

Referring again to FIG. 2, operation of the system 10 generally begins by lowering the rotational tool 12 into the tool cavity 22 with a small clearance in the compression zone 50 and in the plasticization zone 54. As discussed above, the positioning of the rotational tool 12 within the tool cavity 22 can change depending on materials. In an embodiment, the height is automatically determined by the controller 24, and the controller 24 causes the rotational tool 12 to move to the appropriate height. In an embodiment, a user running the system 10 inputs parameters such as the type of material being recycled and/or the desired shape or form of the final extruded material, and the controller 24 automatically moves the rotational tool 12 to the appropriate position within the tool cavity 22 based on those inputs.

The motor 16 then begins rotating the rotational tool 12 around its center axis CA within the tool cavity 22 of the housing 14. The center axis CA of the rotational tool 12 is also the center axis of the tool cavity 22. As discussed above, the rotational speed can change depending on materials. In an embodiment, the rotational speed is automatically determined by the controller 24. In an embodiment, a user running the system 10 inputs parameters such as the type of material being recycled and/or the desired shape or form of the final extruded material, and the controller 24 automatically rotates the rotational tool 12 at the appropriate rotational speed based on those inputs.

The loose chips are fed into the tool cavity 22, for example, by placing the loose chips within the inlet 18 and allowing the tool cavity 22 to be gravity fed. The loose chips can be placed into the inlet 18 area by a user, or the loose chips can be automatically fed into the inlet 18 from another holding area, for example as shown in the alternative embodiments discussed below.

As the rotational tool 12 rotates, the loose chips are driven downward in the axial direction and compressed within the compression zone 50 by the auger portion 30. For example, with the system shown in FIGS. 1 and 2, the loose chips are continuously compressed by the auger thread 38 as the spaces between the auger thread 38 decrease in size as the loose chips are driven further down into the compression zone 50.

Once the loose chips have been compressed, the system 10 drives the compressed material in the axial direction of the rotational axis into the transition zone 52 of the tool cavity 22. The transition zone 52 is important because it allows for a gradual transition to the plasticized material. If the plasticized material were to be heated and plasticized too early, the system 10 could become clogged and inoperable.

The compressed material is then driven into the plasticization zone 54, where the friction stirring portion 32 of the rotational tool 12 that is rotating around the rotational axis within the tool cavity 22 shears, plasticizes and consolidates the compressed material. That is, the friction stirring portion 32 shears the material, which raises the temperature and results in a plasticized material that is soft and deformed. The material is plasticized by the heat generated due to frictional contact between the friction stirring portion 32 and the compressed material. Once plasticized, the material can be consolidated and output as extruded material.

The plasticized material is then extruded in the axial direction from the outlet 20 into the desired extruded material. The outlet 20 and the lower end of the friction stirring portion 32 adjacent the outlet 20 can be configured in different shapes and sizes depending on the desired shape and size of the final extruded material. As discussed above, the extruded material can be formed into a variety of shapes such as rods, wires, tubes and metal matrix composites. As seen in FIG. 6, the extrusion diameter ED or other width or shape generally determines the diameter, width or shape of the extruded material.

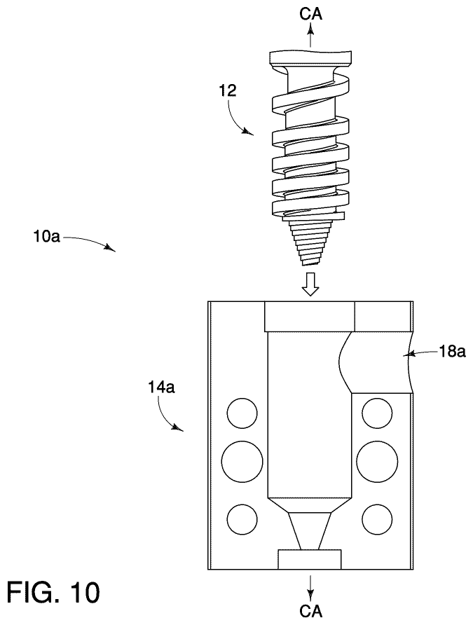

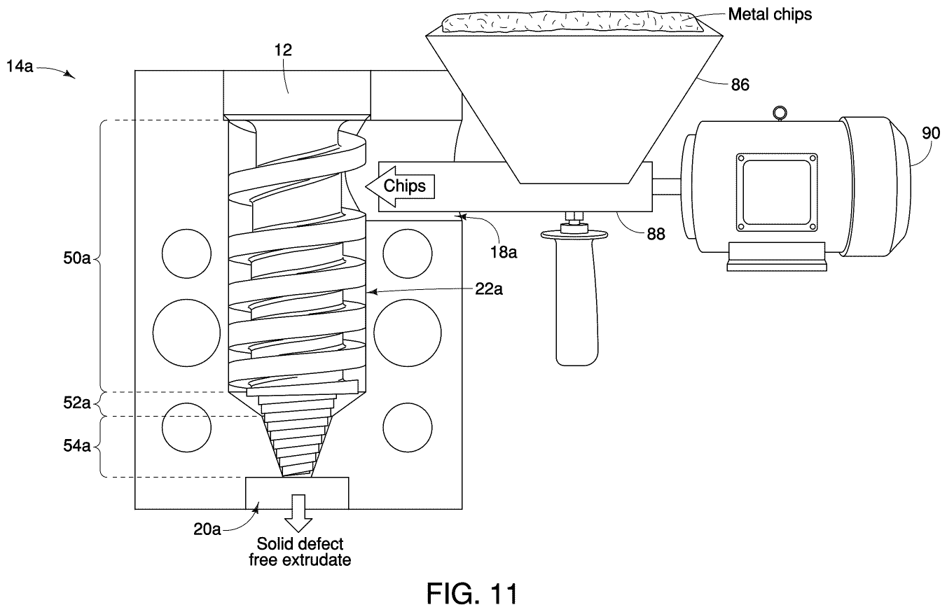

FIGS. 10 and 11 illustrate a second example embodiment of a system 10a configured to produce an extruded material from loose chips in accordance with the present disclosure, with the same or similar reference numbers used to identify common elements with the other embodiments discussed herein. In view of the similarities of the embodiments, the descriptions of the parts that are similar or identical to that of the first example embodiment may be omitted for the sake of brevity.

Like the system 10, the system 10a includes a rotational tool 12, a housing 14a and a motor 16. The housing 14a includes an inlet 18a configured to receive loose chips, an outlet 20a configured to output the extruded material, and a tool cavity 22a connecting the inlet 18a and the outlet 20a. The tool cavity 22a further includes a compression zone 50a, a transition zone 52a and a plasticization zone 54a and as discussed above.

The housing 14a differs from the housing 14 discussed above in that the inlet 18 is a horizontal passage that feeds into the tool cavity 22a at the compression zone 50a. The system 10a further includes a container 86a for the loose chips, a pipe structure 88 enabling the loose chips to flow from the container 86 into the inlet 18a, and a motor 90 configured to cause the loose chips to flow from the container 86, through the pipe structure 88, and into the inlet 18a. In this embodiment, the motor 90 drives an auger within the pipe structure 88 to drive the loose chips through the pipe structure 88 and into the inlet 18a. A controller 24 can control the motor 90 to adjust the feed speed and load quantity, for example, based on a detected torque and/or temperature of the rotational tool 12 and/or within the housing 14a.

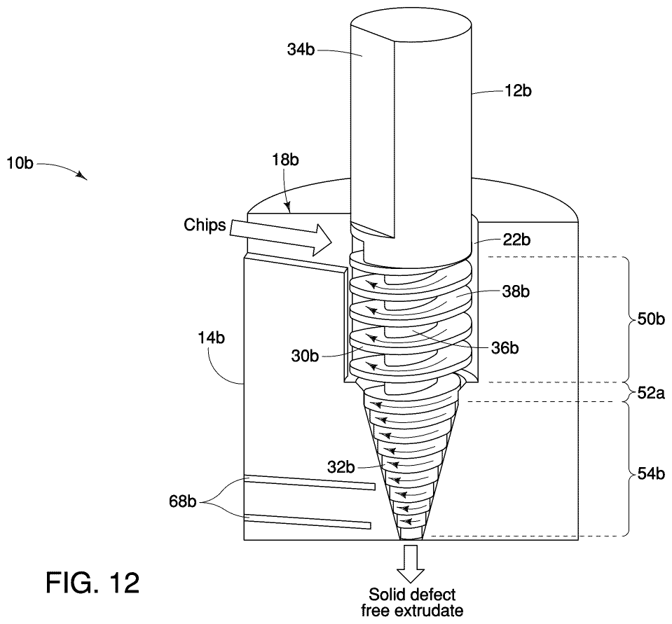

FIG. 12 illustrates a third example embodiment of a system 10b configured to produce an extruded material from loose chips in accordance with the present disclosure. As with the other example embodiments, the same or similar reference numbers are used to identify common elements, and the descriptions of the parts that are similar or identical to that of other embodiments may be omitted for the sake of brevity.

Like the system 10, the system 10b includes a rotational tool 12b, a housing 14b and a motor 16. The rotational tool 12b includes an auger portion 30b, a friction stirring portion 32b, and a tool shank 34b. The auger portion 30b includes an auger shaft 36b and an auger thread 38b. The housing 14b includes an inlet 18b configured to receive loose chips, an outlet 20b configured to output the extruded material, and a tool cavity 22b connecting the inlet 18b and the outlet 20b. The tool cavity includes a compression zone 50b, a transition zone 52b and a plasticization zone 54b.

The rotational tool 12b differs from the rotational tool 12 discussed above in several ways. The auger shaft 36b has a constant diameter, and the auger thread 38b has a constant pitch. The vertical height of the friction stirring portion 32b along the central axis is also relatively longer in comparison to the vertical height of the auger portion 30b. These differences highlight that the dimensions of the system 10 discussed above can change without departing from the spirit and scope of the present disclosure. The housing 14b also differs from the housing 14 discussed above in that the inlet 18b of the housing 14b only partially surrounds the rotational tool 12b.

In the illustrated embodiment, the housing 14b also includes a thermocouple 68b measuring the temperature at the plasticization zone 54b. The thermocouple 68b can include two wires joined at one end and connected to a device configured to measure the temperature. In an embodiment, the controller 24 can be configured to speed up or slow down the revolution rate of the rotational tool 12b depending on the measured temperature, for example, to increase temperature for plasticization if the temperature is too low or to decrease the temperature or stop the system 10b in case of overheating.

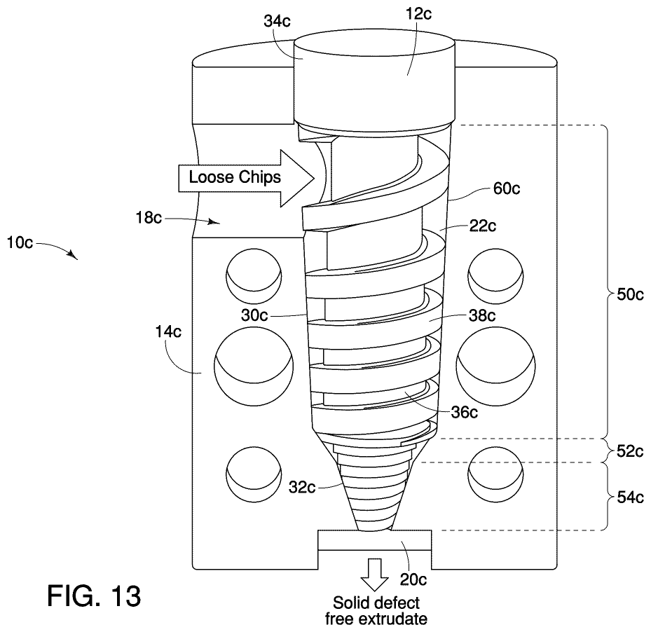

FIG. 13 illustrates a fourth example embodiment of a system 10c configured to produce an extruded material from loose chips in accordance with the present disclosure. As with the other example embodiments, the same or similar reference numbers are used to identify common elements, and the descriptions of the parts that are similar or identical to that of other embodiments may be omitted for the sake of brevity.

Like the system 10, the system 10c includes a rotational tool 12c, a housing 14c and a motor 16. The rotational tool 12c includes an auger portion 30c, a friction stirring portion 32c, and a tool shank 34c. The auger portion 30c includes an auger shaft 36c and an auger thread 38c. The housing 14c includes an inlet 18c configured to receive loose chips, an outlet 20c configured to output the extruded material, and a tool cavity 22c connecting the inlet 18c and the outlet 20c. The tool cavity includes a compression zone 50c, a transition zone 52c and a plasticization zone 54c

The rotational tool 12c differs from the rotational tool 12 discussed above in several ways. The total diameter of the rotational tool 12c to the outside of the auger thread 38c tapers inwardly down the length of auger portion 30c. The inner wall of the compression zone 50c likewise tapers inwardly down the length of the compression zone 50c. The taper creates compression efficiency. These tapered dimensions, which here are further combined with an auger shaft 36 tapering outwardly down the length of the auger portion 30c, cause the loose chips to become increasingly compressed both axially and radially as they approach the friction stirring portion 32c. The housing 14c also differs from the housing 14 discussed above in that the inlet 18c is a horizontal passage that feeds into the tool cavity 22a at the top of the compression zone 50c where the pitch of the auger thread 38c is largest.

In the illustrated embodiment, the inner walls of the tool cavity 12 are angled so that the transition zone 52c prevents unwanted heating of the compression zone 50c. The acute angle of the inner wall of the transition zone 52c with respect to the central axis is larger than the acute angle of the inner wall of the compression zone 50c. The acute angle of the inner wall of the transition zone 52c with respect to the central axis is also larger than the acute angle of the inner wall of the plasticization zone 54c. These angles slow the material between the compression zone 50c and the plasticization zone 54c and act as a reservoir prior to plasticization.

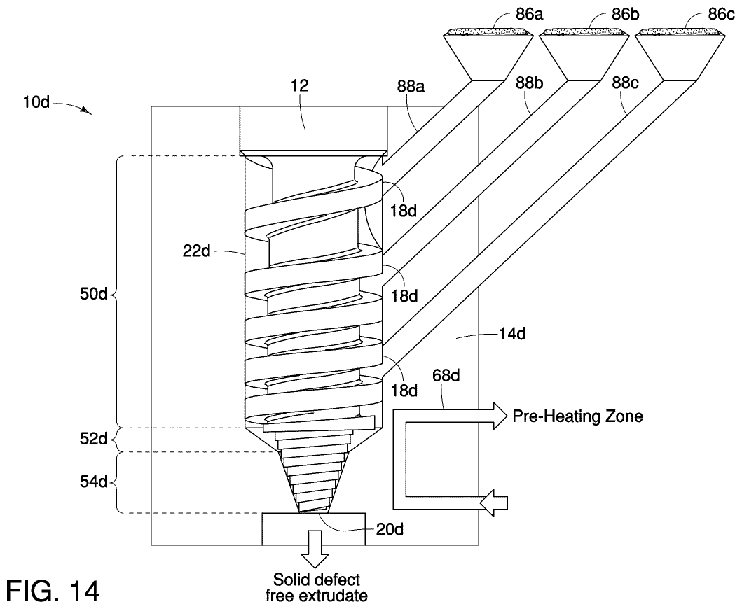

FIG. 14 illustrates a fifth example embodiment of a system 10d configured to produce an extruded material from loose chips in accordance with the present disclosure. As with the other example embodiments, the same or similar reference numbers are used to identify common elements, and the descriptions of the parts that are similar or identical to that of other embodiments may be omitted for the sake of brevity.

Like the system 10, the system 10d includes a rotational tool 12, a housing 14d and a motor 16. The housing 14d includes a plurality of inlets 18d configured to receive loose chips, an outlet 20d configured to output the extruded material, and a tool cavity 22d connecting the inlets 18d and the outlet 20d. The tool cavity 22d includes a compression zone 50d, a transition zone 52d and a plasticization zone 54d. The system 10d further includes a heat transfer mechanism 68d, a plurality of containers 86a, 86b, 86c for the loose chips, and a plurality of pipe structures 88a, 88b, 88c enabling the loose chips to flow from the containers 86a, 86b, 86c into the inlets 18d.

The heat transfer mechanism 68d is configured to add or remove heat from the plasticization zone 54d. The heat transfer mechanism 68d can also be configured to add or remove heat from the transition zone 52d. In an embodiment, a heating liquid is pumped through the heat transfer mechanism 68d to increase the temperature in the plasticization zone 54d and assist plasticization of the material. In another embodiment, a cooling liquid is pumped through the heat transfer mechanism 68d to remove heat and lower the temperature within the transition zone 52d and/or plasticization zone 54d. In an embodiment, the controller 24 can detect the temperature within the transition zone 52d and/or plasticization zone 54d and pump the heating or cooling liquid through the heat transfer mechanism 68d as needed when the temperature reaches one or more predetermined threshold.

The plurality of containers 86a, 86b, 86c and the plurality of pipe structures 88a, 88b, 88c enable the system 10d to input metal chips into the tool cavity 22d at a plurality of inlets 18d located at different vertical locations of the compression zone 50d. This embodiment can be advantageous, for example, for controlling the flow of metal chips or for inputting different sizes of metal chips at different locations.

FIGS. 15 to 17 illustrate an alternative example embodiment of a rotational tool 12e. As with the other example embodiments, the same or similar reference numbers are used to identify common elements, and the descriptions of the parts that are similar or identical to that of other embodiments may be omitted for the sake of brevity.

Similar to the previous embodiments, the rotational tool 12e includes an auger portion 30e, a friction stirring portion 32e, and a tool shank 34e. As seen for example in FIG. 17, however, the rotational tool 12e is formed by a first part 92 and a second part 94. The first part 92 and the second part 94 are configured to rotate around the central axis of the rotational tool 12e independently of each other.

The first part 92 includes the friction stirring portion 32e and the tool shank 34e. More specifically, the first part 92 includes a shaft 96 extending in the axial direction of the center axis CA which connects the friction stirring portion 32e and the tool shank 34e. The friction stirring portion 32e, the tool shank 34e and the shaft 96 thus rotate together.

The second part 94 includes the auger portion 30e. In this embodiment, the auger portion 30e includes a central aperture 98 which receives the shaft 96. The auger portion 30e thus encircles the shaft 96 in a radial direction of the center axis CA.

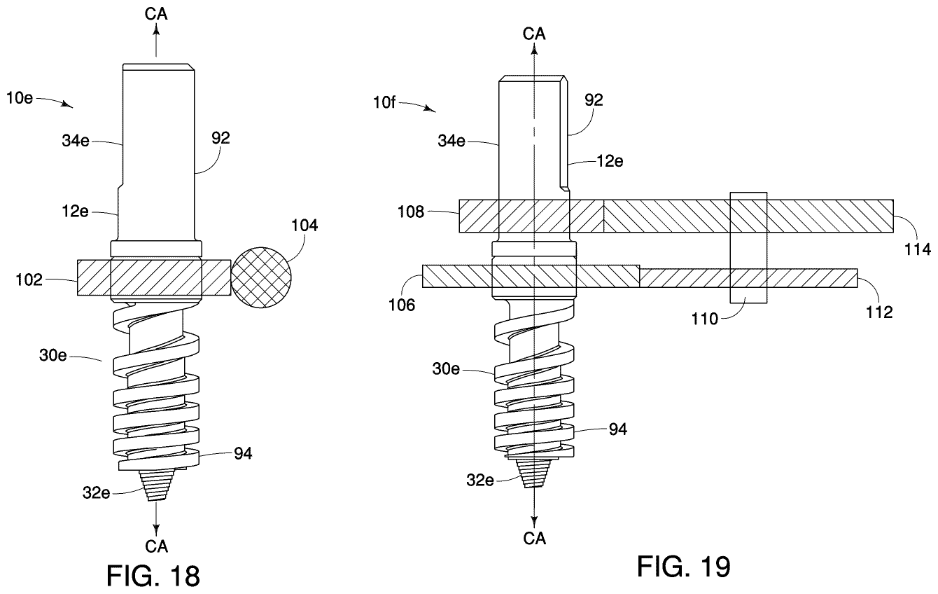

The rotational tool 12e further includes bearings 100 that enable the first part 92 and the second part 94 to rotate freely and independently. The bearings 100 can include, for example, ring and ball bearings. The auger portion 30e and the friction stirring portion 32e are thus configured to rotate at different speeds. FIGS. 18 and 19 illustrate two example embodiments of systems 10e, 10f configured to rotate the auger portion 30e and the friction stirring portion 32e at different speeds.

FIG. 18 illustrates a first example embodiment of a system 10e configured to rotate the auger portion 30e and the friction stirring portion 32e at different speeds. The system 10e includes a motor 16 (not shown) which rotates the first part 92, for example, by operatively connecting to and rotating the tool shank 34e as discussed above. The system 10e further includes a first gear 102 fixed to the second part 94 and operatively connected to a second gear 104. In the illustrated embodiment, the second gear 104 is a worm gear driven by the same or another motor 16, such that the motion of the second gear 104 transfers to the first gear 102 to cause the first gear 102 to rotate the second part 94 at a different rotation rate as compared to first part 92.

FIG. 19 illustrates a second example embodiment of a system 10f configured to rotate the auger portion 30e and the friction stirring portion 32e at different speeds. The system 10f includes a first gear 106 fixed to the second part 94 and a second gear 108 fixed to the first part 92. The system 10f further includes a motor shaft or gear 110 that drives a third gear 112 and a fourth gear 114. The third gear 112 drives the first gear 106 to rotate the second part 94, while the fourth gear 114 drives the second gear 108 to rotate the first part 94. The size of the gears 106, 108, 112, 114 can be adjusted so that the rotational force transferred from the motor shaft or gear 110 causes the first part 92 and the second part 94 to rotate at different speeds.

The systems 10e, 10f are thus configured to rotate the auger portion 30e of the rotational tool 12e at a different speed than the friction stirring portion 32e of the rotational tool 12e. For example, it can be advantageous to rotate the friction stirring portion 32e at a faster speed than the auger portion 32e to plasticize materials more quickly if the compression zone 50 is backed up. Rotating the auger portion 30e at a slower rate can also be advantageous because it is undesirable to have the compressed material heat up and plasticize within the compression zone 50, which can clog the auger portion 30e. Rotating the auger portion 30e and the friction stirring portion 32e independently of each other allows for the auger portion 30e to rotate slowly enough to avoid undesirable heating while at the same time allowing the friction stirring portion 32e to rotate fast enough for optimal shearing and plasticization and thus the formation of defect free extrudates. Rotating the auger portion 30e and the friction stirring portion 32e independently of each other can further eliminate the need for a cooling jacket 68 around the compression zone 50. Independent control of the auger portion 30e also allows for better control of loose chip compression.

The relative sizes and dimensions of the parts shown in various embodiments discussed herein herein provide several examples configured to produce defect free extrudates from loose chips. These systems can be scaled to different sizes, for example, to create recycled/upcycled extrudates of different sizes ranging from 1.5 mm diameter to 25 mm diameter, and the extrudates can be of different cross-sectional types such as square, hexagon, triangular or circular hollow tubes, pipes, etc. It should also be understood by those of ordinary skill in the art from this disclosure that any of the features of any of the embodiments disclosed herein can be combined with any of the features of other embodiments.

The embodiments described herein provide improved systems and methods of recycling or upcycling loose metal chips created during various manufacturing processes. These systems and methods are advantageous, for example, because they create extruded materials that have little or no impurities or defects, as well as improved mechanical properties such as tensile strength, yield strength, ductility and hardness. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A system for producing an extruded material from loose chips, the system comprising:
a rotational tool configured to rotate around a center axis thereof, the rotational tool including an auger portion that transitions to a friction stirring portion along the center axis;
a housing having an inlet configured to receive the loose chips, an outlet configured to output the extruded material, and a tool cavity connecting the inlet and the outlet, the tool cavity including a compression zone containing the auger portion of the rotational tool, a plasticization zone containing the friction stirring portion of the rotational tool, and a transition zone surrounding the rotational tool where the auger portion transitions to the friction stirring portion; and
a motor configured to rotate the rotational tool within the tool cavity to cause the loose chips to flow from the inlet, through the tool cavity, and out of the outlet as the extruded material.

2. The system of claim 1, wherein
the transition zone includes a first inner wall positioned at a first acute angle with respect to the center axis of the rotational tool,
the plasticization zone includes a second inner wall positioned at a second acute angle with respect to the center axis of the rotational tool, and
the first acute angle is larger than the second acute angle.

3. The system of claim 2, wherein
the compression zone includes a third inner wall positioned at a third acute angle with respect to the center axis of the rotational tool, and
the third acute angle is smaller than the second acute angle.

4. The system of claim 1, wherein
the compression zone includes a cylindrical inner wall with a constant diameter.

5. The system of claim 1, wherein
the auger portion includes a shaft and an auger thread, and
the friction stirring portion includes a stepped spiral having a first end and a second end, the first end closer to the auger portion than the second end, the stepped spiral decreasing in diameter from the first end to the second end.

6. The system of claim 1, wherein
the housing includes a cooling jacket located radially outward from the tool cavity with respect to the center axis of the rotational tool.

7. The system of claim 1, wherein
the center axis of the rotational tool is a vertical axis.

8. The system of claim 7, wherein
the inlet encircles the center axis of the rotational tool and is located above the compression zone in an axial direction of the center axis.

9. A system for producing an extruded material from loose chips, the system comprising:
a housing having an inlet configured to receive the loose chips, an outlet configured to output the extruded material, and a tool cavity connecting the inlet and the outlet;
a rotational tool located within the tool cavity and configured to rotate around a center axis thereof, the rotational tool including an auger portion and a friction stirring portion along the center axis, the auger portion having an auger thread configured to compress the loose chips received at the inlet, the friction stirring portion having a tapering diameter configured to plasticize the loose chips compressed by the auger portion to be output as the extruded material from the outlet; and
a motor configured to rotate the rotational tool within the tool cavity to cause the loose chips to flow from the inlet, through the tool cavity, and out of the outlet as the extruded material.

10. The system of claim 9, wherein
the auger thread is a constant pitched auger thread.

11. The system of claim 9, wherein
the auger portion includes a tapered shaft with a first end and a second end, the second end closer to the friction stirring portion than the first end and having a larger diameter than the first end.

12. The system of claim 9, wherein
the friction stirring portion including a stepped spiral portion having a first end and a second end, the first end closer to the auger portion than the second end, the stepped spiral portion decreasing in diameter from the first end to the second end.

13. The system of claim 9, wherein
the auger portion includes a first end, a second end, and a variable pitched auger thread,
the second end is closer to the friction stirring portion than the first end, and
the variable pitched auger thread has a smaller pitch at the second end than the first end.

14. The system of claim 9, wherein
the auger portion and the friction stirring portion are configured to rotate at different speeds.

15. The system of claim 9, wherein
the friction stirring portion extends from a shaft in an axial direction of the center axis, and
the auger portion encircles the shaft in a radial direction of the center axis and rotates independently of the friction stirring portion.

16. A method for producing an extruded material from loose chips, the method comprising:
feeding the loose chips into a tool cavity;
compressing the loose chips with an auger portion of a rotational tool that is rotating around a rotational axis within the tool cavity;
passing the compressed loose chips in an axial direction of the rotational axis through a transition zone of the tool cavity;
plasticizing the compressed loose chips into a plasticized material with a friction stirring portion of the rotating tool that is rotating around the rotational axis within the tool cavity; and
extruding the plasticized material from an outlet of the tool cavity.

17. The method of claim 16, comprising
rotating the auger portion of the rotational tool at a different speed than the friction stirring portion of the rotating tool.

18. The method of claim 17, comprising
rotating the friction stirring portion at a faster speed than the auger portion.

19. The method of claim 16, comprising
automatically adjusting a speed that the loose chips are fed into the inlet based on a detected torque of the rotational tool or a detected temperature within the tool cavity.

20. The method of claim 16, wherein
feeding the loose chips into the tool cavity includes feeding the loose chips into a tapered extension of the tool cavity surrounding an upper part of the auger portion of the rotational tool.
